(19) United States
(12) Patent Application Publication
(10) Pub. No.: US 2023/0114589 A1
(43) Pub. Date: Apr. 13, 2023

(54) METHOD AND SYSTEM FOR ADAPTIVE ASSET ALLOCATION AND FINANCIAL PLANNING

(71) Applicant: JPMorgan Chase Bank, N.A., New York, NY (US)

(72) Inventors: Martin W. SIOW, New York, NY (US); Junyang HONG, New York, NY (US); Angela Y. CHOI, New York, NY (US); Georgiy ZHIKHAREV, Englewood Cliffs, NJ (US)

(73) Assignee: JPMorgan Chase Bank, N.A., New York, NY (US)

(21) Appl. No.: 17/963,717

(22) Filed: Oct. 11, 2022

Related U.S. Application Data
(60) Provisional application No. 63/262,409, filed on Oct. 12, 2021.

(51) Int. Cl. G06Q 40/06

(52) U.S. Cl. CPC G06Q 40/06

(57) ABSTRACT

Method and systems for adaptively allocating assets in an investment portfolio are provided. The method includes: receiving first information relating to an investment portfolio of an investor; receiving second information relating to several financial goals of the investor; determining, based on the second information, respective estimated costs for achieving each corresponding financial goal; determining, based on the first information and the second information, a current status and proposed adjustments, including to asset allocation among asset classes, that relate to achieving the financial goals; and outputting third information that relates to the determined costs, the current status, and the proposed adjustments, including to asset allocation among asset classes.

### CROSS-REFERENCE TO RELATED APPLICATIONS

This application claims priority benefit from U.S. Provisional Application No. 63/262,409, filed Oct. 12, 2021, which is hereby incorporated by reference in its entirety.

### BACKGROUND

### 1. Field of the Disclosure

This technology generally relates to methods and systems for financial planning and wealth accumulation and wealth decumulation, and more particularly to methods and systems for adaptively allocating assets and estimating cost objectives in the context of a long-term financial plan for achieving specific goals in relation to wealth accumulation and decumulation.

### 2. Background Information

In the financial services industry, there are many investment advisers that assist clients with financial planning, and there are many conventional software algorithms that have been developed for wealth planning purposes. For these conventional algorithms, a typical objective is to answer a question regarding a likelihood that a particular investor will achieve a set of stated spending goals, based on input parameters that relate to the amounts needed for each spending goal, a selected portfolio of securities, and information that indicates current and expected future resources that are available to the investor.

However, in many cases, a particular investor may prefer to learn other types of information relating to financial planning for his/her future, including answers to questions relating to a respective amount that would be needed to reach a corresponding goal; funding status for reaching a particular goal; and how much current spending can be adjusted, either upward or downward, in order to achieve the particular goal; and how his/her current and future financial resources should be optimally allocated among different asset classes (e.g., equities versus fixed income). Accordingly, there is a need for a methodology for enabling investors to 1) allocate resources into different groupings and 2) optimally allocate these resources among different asset classes, in order to facilitate tracking of financial progress on a per-goal basis.

### SUMMARY

The present disclosure, through one or more of its various aspects, embodiments, and/or specific features or sub-components, provides, inter alia, various systems, servers, devices, methods, media, programs, and platforms for adaptively allocating assets in different groupings and among different asset classes and estimating cost objectives in the context of a long-term financial plan for achieving specific goals in relation to wealth accumulation and decumulation.

According to an aspect of the present disclosure, a method for adaptively allocating assets in an investment portfolio is provided. The method is implemented by at least one processor. The method includes: receiving, by the at least one processor, first information relating to an investment portfolio of an investor; receiving, by the at least one processor, second information relating to at least one financial goal of the investor; determining, by the at least one processor based on the second information, a respective estimated cost for achieving each corresponding one of the at least one financial goal; determining, by the at least one processor based on the first information and the second information, a current status and at least one proposed adjustment that relate to achieving the at least one financial goal; and outputting, by the at least one processor, third information that relates to each determined estimated cost, the determined current status, and the determined at least one proposed adjustment.

The first information may include an identification of each of a plurality of financial assets included in the investment portfolio and a value of each identified financial asset.

The first information may further include a projection relating to future income that is expected to be received within a predetermined time frame.

The at least one financial goal may include at least one from among a retirement goal, a health care goal, a goal that relates to funding for a college education, a goal that relates to purchasing real estate, a goal that relates to purchasing a tangible object, a goal that relates to an inheritance to be bequeathed to at least one heir, a goal that relates to a charitable contribution, and a goal that relates to current liquidity.

The second information may include an identification of each respective one of the at least one financial goal, a corresponding estimated probability of achieving each identified financial goal, and a rank-ordered listing that indicates a relative importance of each identified financial goal.

The at least one proposed adjustment may include a proposed adjustment to an asset allocation among a plurality of asset classes.

The determining of the respective estimated cost for achieving each corresponding one of the at least one financial goal may include applying a first algorithm with respect to the first information and the second information and by using a plurality of simulations to generate a range of outcomes of the respective estimated cost as an output of the first algorithm.

The method may further include displaying, via a graphical user interface (GUI), at least a portion of the third information.

The GUI may include at least one from among a first clickable link that facilitates access to explanatory information that relates to the displayed portion of the third information and a second clickable link that facilitates a user selection of a risk level that is associated with the displayed portion of the third information.

According to another exemplary embodiment, a computing apparatus for adaptively allocating assets in an investment portfolio is provided. The computing apparatus includes a processor; a memory; a display; and a communication interface coupled to each of the processor, the memory, and the display. The processor is configured to: receive, via the communication interface, first information relating to an investment portfolio of an investor; receive, via the communication interface, second information relating to at least one financial goal of the investor; determine, based on the second information, a respective estimated cost for achieving each corresponding one of the at least one financial goal; determine, based on the first information and the second information, a current status and at least one proposed adjustment that relate to achieving the at least one financial goal; and output third information that relates to each determined estimated cost, the determined current status, and the determined at least one proposed adjustment.

The first information may include an identification of each of a plurality of financial assets included in the investment portfolio and a value of each identified financial asset.

The first information may further include a projection relating to future income that is expected to be received within a predetermined time frame.

The at least one financial goal may include at least one from among a retirement goal, a health care goal, a goal that relates to funding for a college education, a goal that relates to purchasing real estate, a goal that relates to purchasing a tangible object, a goal that relates to an inheritance to be bequeathed to at least one heir, a goal that relates to a charitable contribution, and a goal that relates to current liquidity.

The second information may include an identification of each respective one of the at least one financial goal, a corresponding estimated probability of achieving each identified financial goal, and a rank-ordered listing that indicates a relative importance of each identified financial goal.

The at least one proposed adjustment may include a proposed adjustment to an asset allocation among a plurality of asset classes.

The processor may be further configured to determine the respective estimated cost for achieving each corresponding one of the at least one financial goal by applying a first algorithm with respect to the first information and the second information and by using a plurality of simulations to generate a range of outcomes of the respective estimated cost as an output of the first algorithm.

The processor may be further configured to cause the display to display, via a graphical user interface (GUI), at least a portion of the third information.

The GUI may include at least one from among a first clickable link that facilitates access to explanatory information that relates to the displayed portion of the third information and a second clickable link that facilitates a user selection of a risk level that is associated with the displayed portion of the third information.

According to yet another exemplary embodiment, a non-transitory computer readable storage medium storing instructions for adaptively allocating assets in an investment portfolio is provided. The storage medium includes executable code which, when executed by a processor, causes the processor to: receive first information relating to an investment portfolio of an investor; receive second information relating to at least one financial goal of the investor; determine, based on the second information, a respective estimated cost for achieving each corresponding one of the at least one financial goal; determine, based on the first information and the second information, a current status and at least one proposed adjustment that relate to achieving the at least one financial goal; and output third information that relates to each determined estimated cost, the determined current status, and the determined at least one proposed adjustment.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for adaptively allocating assets and estimating cost objectives in the context of a long-term financial plan for achieving specific goals in relation to wealth accumulation and decumulation.

FIG. 4 is a flowchart of an exemplary process for implementing a method for adaptively allocating assets and estimating cost objectives in the context of a long-term financial plan for achieving specific goals in relation to wealth accumulation and decumulation.

FIG. 5A and FIG. 5B are portions of a first screen shot of a user interface that is displayed during the execution of a method for adaptively allocating assets and estimating cost objectives in the context of a long-term financial plan for achieving specific goals in relation to wealth accumulation and decumulation, according to an exemplary embodiment.

FIG. 6 is a second screen shot of a user interface that is displayed during the execution of a method for adaptively allocating assets and estimating cost objectives in the context of a long-term financial plan for achieving specific goals in relation to wealth accumulation and decumulation, according to an exemplary embodiment.

FIG. 7 is a third screen shot of a user interface that is displayed during the execution of a method for adaptively allocating assets and estimating cost objectives in the context of a long-term financial plan for achieving specific goals in relation to wealth accumulation and decumulation, according to an exemplary embodiment.

FIG. 8 is a diagram that illustrates a set of algorithms for determining an optimal asset allocation among asset classes in the context of a long-term financial plan for achieving specific goals in relation to wealth accumulation and decumulation, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

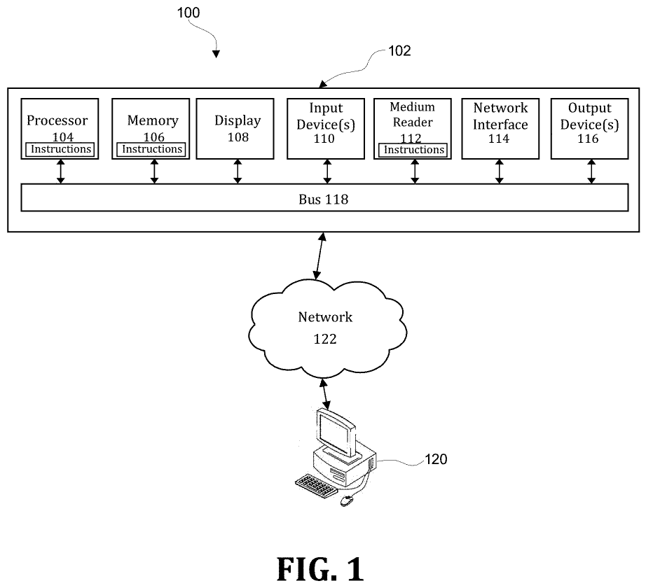

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for adaptively allocating assets and estimating cost objectives in the context of a long-term financial plan for achieving specific goals in relation to wealth accumulation and decumulation.

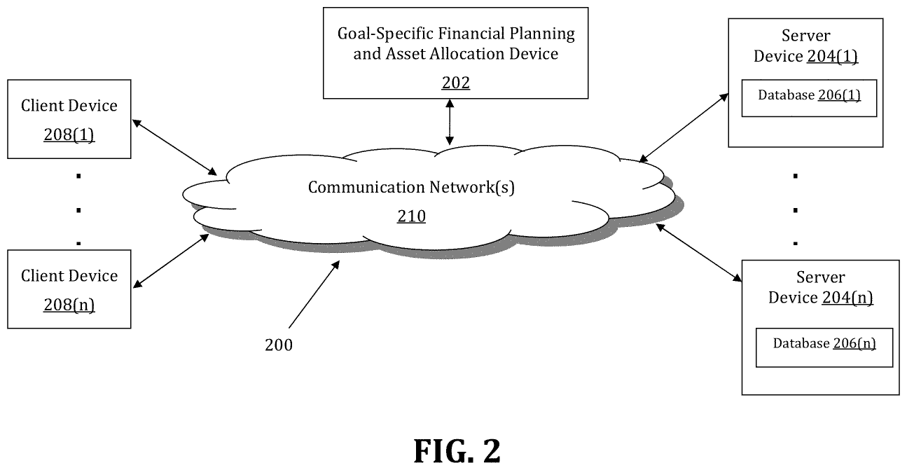

Referring to FIG. 2, a schematic of an exemplary network environment 200 for implementing a method for adaptively allocating assets and estimating cost objectives in the context of a long-term financial plan for achieving specific goals in relation to wealth accumulation and decumulation is illustrated. In an exemplary embodiment, the method is executable on any networked computer platform, such as, for example, a personal computer (PC).

The method for adaptively allocating assets and estimating cost objectives in the context of a long-term financial plan for achieving specific goals in relation to wealth accumulation and decumulation may be implemented by a Goal-Specific Financial Planning and Asset Allocation (GSFPAA) device 202. The GSFPAA device 202 may be the same or similar to the computer system 102 as described with respect to FIG. 1. The GSFPAA device 202 may store one or more applications that can include executable instructions that, when executed by the GSFPAA device 202, cause the GSFPAA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GSFPAA device 202 itself, may be located in virtual server(s) running in a cloud-based computing environment rather than being tied to one or more specific physical network computing devices. Also, the application(s) may be running in one or more virtual machines (VMs) executing on the GSFPAA device 202. Additionally, in one or more embodiments of this technology, virtual machine(s) running on the GSFPAA device 202 may be managed or supervised by a hypervisor.

In the network environment 200 of FIG. 2, the GSFPAA device 202 is coupled to a plurality of server devices 204(1)-204(n) that hosts a plurality of databases 206(1)-206(n), and also to a plurality of client devices 208(1)-208(n) via communication network(s) 210. A communication interface of the GSFPAA device 202, such as the network interface 114 of the computer system 102 of FIG. 1, operatively couples and communicates between the GSFPAA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GSFPAA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and GSFPAA devices that efficiently implement a method for adaptively allocating assets and estimating cost objectives in the context of a long-term financial plan for achieving specific goals in relation to wealth accumulation and decumulation.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The GSFPAA device 202 may be a standalone device or integrated with one or more other devices or apparatuses, such as one or more of the server devices 204(1)-204(n), for example. In one particular example, the GSFPAA device 202 may include or be hosted by one of the server devices 204(1)-204(n), and other arrangements are also possible. Moreover, one or more of the devices of the GSFPAA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the GSFPAA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user-specific financial planning information and data that relates to estimating a cost of a future financial goal.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the GSFPAA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the GSFPAA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the GSFPAA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GSFPAA device 202, the server devices 204(1)-204(n), or the client devices 208(1)-208(n), for example, may be configured to operate as virtual instances on the same physical machine. In other words, one or more of the GSFPAA device 202, the server devices 204(1)-204(n), or the client devices 208(1)-208(n) may operate on the same physical device rather than as separate devices communicating through communication network(s) 210. Additionally, there may be more or fewer GSFPAA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

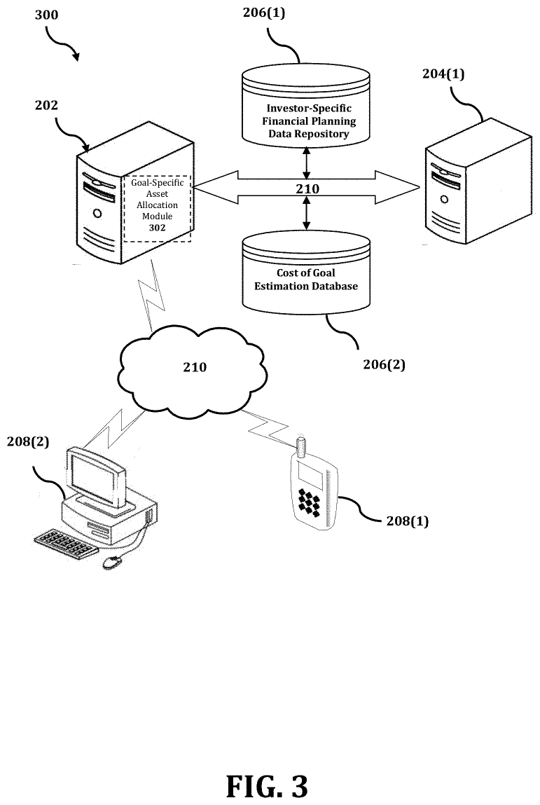

The GSFPAA device 202 is described and illustrated in FIG. 3 as including a goal-specific asset allocation module 302, although it may include other rules, policies, modules, databases, or applications, for example. As will be described below, the goal-specific asset allocation module 302 is configured to implement a method for adaptively allocating assets and estimating cost objectives in the context of a long-term financial plan for achieving specific goals in relation to wealth accumulation and decumulation.

An exemplary process 300 for implementing a mechanism for adaptively allocating assets and estimating cost objectives in the context of a long-term financial plan for achieving specific goals in relation to wealth accumulation and decumulation by utilizing the network environment of FIG. 2 is illustrated as being executed in FIG. 3. Specifically, a first client device 208(1) and a second client device 208(2) are illustrated as being in communication with GSFPAA device 202. In this regard, the first client device 208(1) and the second client device 208(2) may be “clients” of the GSFPAA device 202 and are described herein as such. Nevertheless, it is to be known and understood that the first client device 208(1) and/or the second client device 208(2) need not necessarily be “clients” of the GSFPAA device 202, or any entity described in association therewith herein. Any additional or alternative relationship may exist between either or both of the first client device 208(1) and the second client device 208(2) and the GSFPAA device 202, or no relationship may exist.

Further, GSFPAA device 202 is illustrated as being able to access an investor-specific financial planning data repository 206(1) and a cost of goal estimation database 206(2). The goal-specific asset allocation module 302 may be configured to access these databases for implementing a method for adaptively allocating assets and estimating cost objectives in the context of a long-term financial plan for achieving specific goals in relation to wealth accumulation and decumulation.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the GSFPAA device 202 via broadband or cellular communication. Of course, these embodiments are merely exemplary and are not limiting or exhaustive.

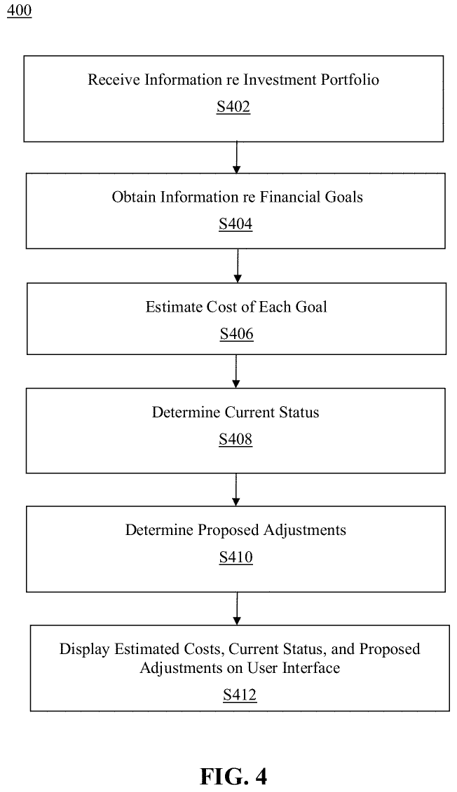

Upon being started, the goal-specific asset allocation module 302 executes a process for adaptively allocating assets and estimating cost objectives in the context of a long-term financial plan for achieving specific goals in relation to wealth accumulation and decumulation. An exemplary process for adaptively allocating assets and estimating cost objectives in the context of a long-term financial plan for achieving specific goals in relation to wealth accumulation and decumulation is generally indicated at flowchart 400 in FIG. 4.

In process 400 of FIG. 4, at step S402, the goal-specific asset allocation module 302 receives information that relates to an investment portfolio of a particular investor. In an exemplary embodiment, the information relating to the investment portfolio includes several items, including a list of stocks, bonds, and other securities, and the respective numbers of shares and valuations of each; a list of accounts that hold current balances in dollars or other currencies; and any other financial asset, together with a valuation thereof. The information may further include a projection relating to future income that is expected to be received within a predetermined time frame, such as compensation from employment, annuities, pensions, Social Security payments, and/or any other type of income from any known source.

At step S404, the goal-specific asset allocation module 302 receives information that relates to financial goals that relate to the particular investor. In an exemplary embodiment, the financial goals may include any one or more of the following: a retirement goal, a health care goal, a goal that relates to funding for a college education, a goal that relates to purchasing real estate (e.g., a primary residence, such as a house or a condominium, or a second home, such as a vacation house or an investment property to be used as a rental property), a goal that relates to purchasing a tangible object (e.g., an automobile, an item of jewelry, furniture, a musical instrument, or a recreational vehicle such as a boat), a goal that relates to an inheritance to be bequeathed ones heir, a goal that relates to charitable contributions, and a goal that relates to current liquidity. The information relating to financial goals may also include an estimated probability of achieving each goal and a rank-ordered listing that indicates a relative importance of each goal. In an exemplary embodiment, when the number of financial goals for a particular investor is relatively large (i.e., greater than five), the goals may be grouped into “buckets” that correspond to goal types, such as lifecycle-related goals (i.e., retirement and large purchases), legacy goals (i.e., inheritance/estate and charity), and short-term liquidity goals.

At step S406, the goal-specific asset allocation module 302 determines an estimated cost of each goal. In an exemplary embodiment, the estimated cost may be expressed as a target number of dollars, or any other amount of currency. The estimated cost may also be expressed as a target amount to be available for spending on a monthly basis, a yearly basis, a weekly basis, or over any suitable time frame. In an exemplary embodiment, the determination of the estimated cost of each goal may be performed by applying an algorithm with respect to the information received in steps S402 and S404, i.e., the information that relates to an investment portfolio of a particular investor and the information that relates to financial goals that relate to the particular investor. In an exemplary embodiment, the algorithm uses simulations to generate a range of outcomes of the respective estimated cost as an output thereof.

At step S408, the goal-specific asset allocation module 302 determines a current status with respect to the investor's ability to achieve each financial goal. Then, at step S410, the goal-specific asset allocation module 302 determines one or more proposed adjustments for increasing a likelihood of achieving at least one of the financial goals. In an exemplary embodiment, the determination of the current status may include assessing a net worth of the entire investment portfolio and a projected total value at a predetermined time horizon; and the proposed adjustments may include tradeoffs between short-term savings and longer-term investments; shifting of resources toward higher-priority goals and away from lower-priority goals; and also recommendations relating to adjusting spending amounts, retirement timelines, and/or any other suitable type of recommendations for proposed adjustments.

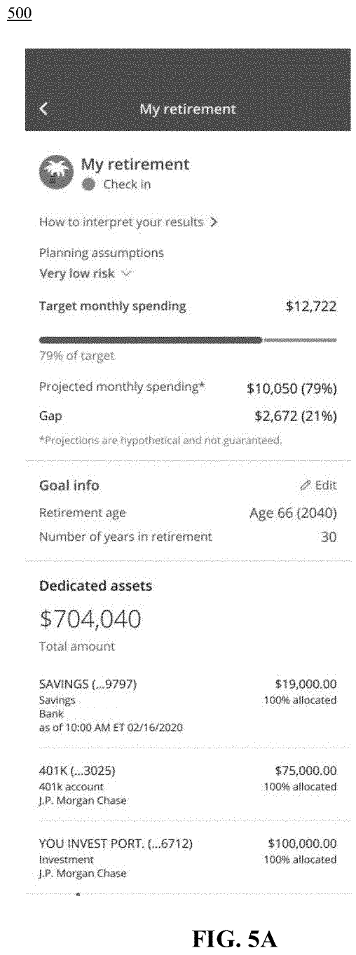

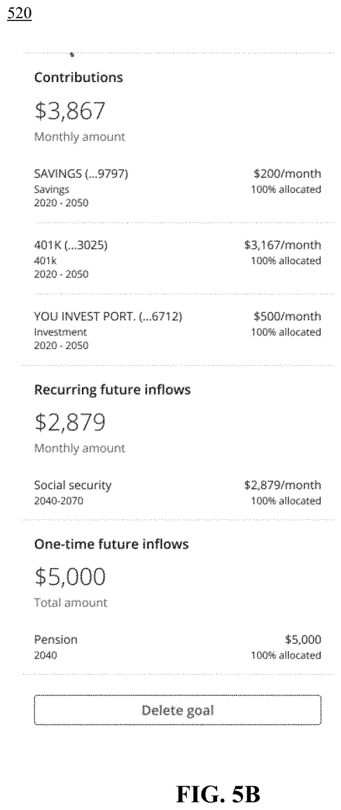

At step S412, the goal-specific asset allocation module 302 displays estimated costs, current status, and proposed adjustments on a user interface. Referring to FIG. 5A and FIG. 5B, exemplary portions 500 and 520 of a first screen shot of such a user interface are illustrated.

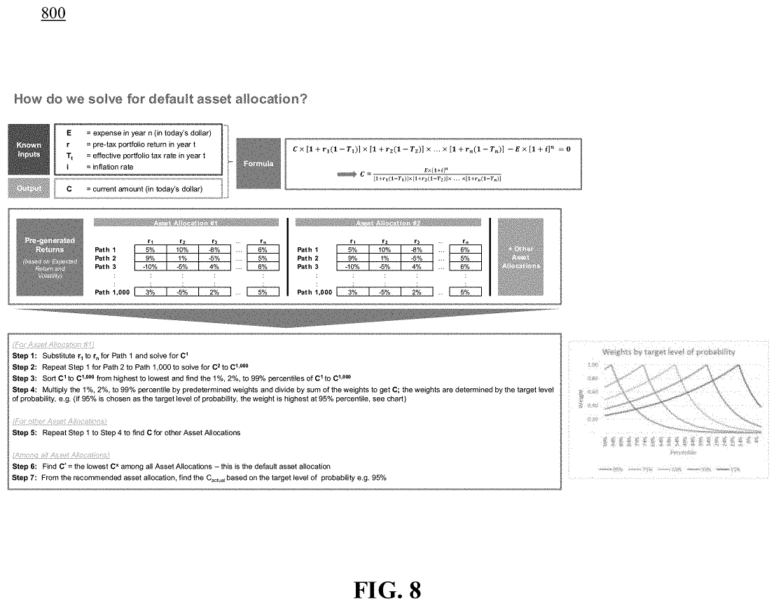

In an exemplary embodiment, the goal-specific asset allocation module 302 makes an optimal recommendation for asset allocation among asset classes for each goal. The optimal asset allocation among asset classes may be determined by a set of algorithms that is further described below with reference to FIG. 8.

In FIG. 5A, examples of several items of information that relate to a retirement goal for a hypothetical investor are shown, and the user interface also includes clickable items that enable a user to access additional information. The clickable items include a first link labeled “How to interpret your results” and a second link labeled “Planning assumptions” that is combined with a clickable drop-down menu labeled “Very low risk”. By clicking on the first link, a user may access explanatory information that relates to the other information shown on the screen. By clicking on the second link, the user may access information that relates to which assumptions are made for a “very low risk” assessment, and by clicking on the drop-down menu, the user may be prompted to select any of various risk levels that are associated with assumptions that may have a significant effect on the other information shown on the screen. In an exemplary embodiment, the term “risk level” refers to an estimated probability of achieving a particular financial goal.

The informational items in screen shot 500 include a targeted monthly spending goal amount of $12,722; a projected monthly spending amount of $10,050 that is calculated based on current assets and projected income; and a gap amount that represents a difference between the target amount and the projected amount, expressed as both a dollar amount and a percentage. The user interface also shows a projected retirement age; a year at which that age would be reached; a projected number of years in retirement; a total amount (expressed in dollars) of dedicated assets; and a breakdown of current assets by account name and type.

Referring to FIG. 5B, examples of additional informational items are shown in screen shot 520, including: a total dollar amount of projected monthly contributions by the investor; a breakdown of the projected monthly contributions by account name and type; a listing of recurring future inflows; and a listing of one-time future inflows. A button that enables the user to delete the goal is also shown.

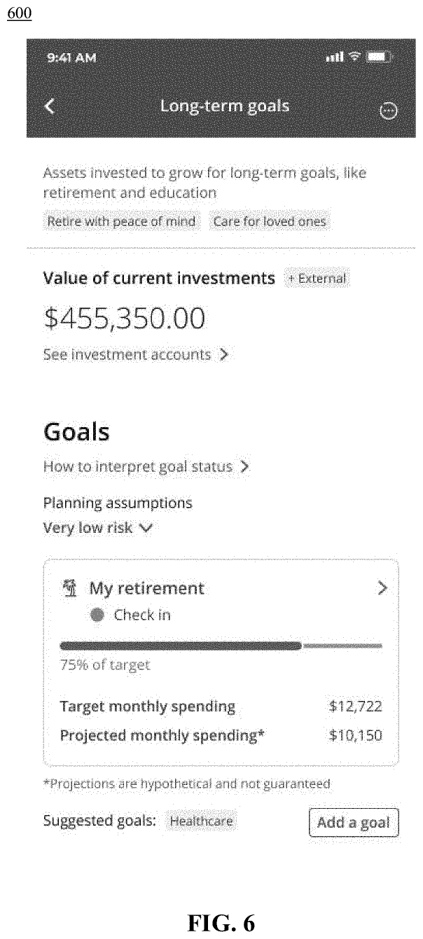

FIG. 6 is a second screen shot 600 of a user interface that is displayed during the execution of a method for adaptively allocating assets and estimating cost objectives in the context of a long-term financial plan for achieving specific goals in relation to wealth accumulation, according to an exemplary embodiment. As illustrated in FIG. 6, several informational items and clickable links and buttons that relate to the long-term goal of retirement are shown. The informational items include: a total value, expressed as a dollar amount, of current investments; a target monthly spending goal, expressed as a dollar amount; and a projected monthly spending amount. The clickable links and buttons include: a link to a list of investment accounts; a link for accessing information relating to interpreting goal status; a drop-down menu for selecting a risk level for planning assumptions; and a button for adding a goal.

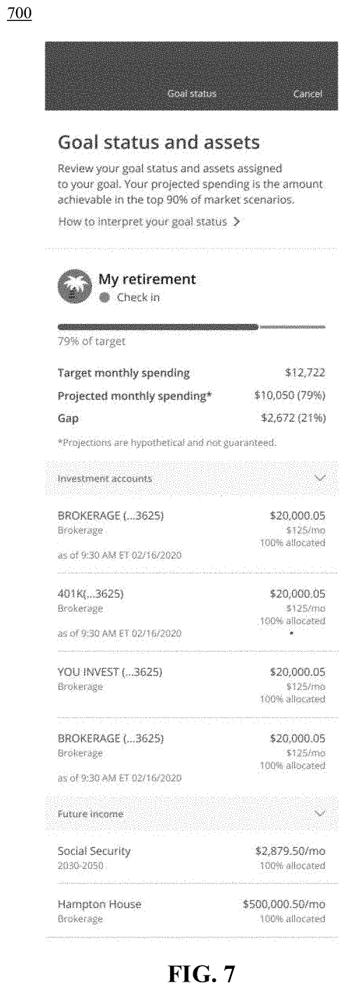

FIG. 7 is a third screen shot 700 of a user interface that is displayed during the execution of a method for adaptively allocating assets and estimating cost objectives in the context of a long-term financial plan for achieving specific goals in relation to wealth accumulation, according to an exemplary embodiment. As illustrated in FIG. 7, several informational items that relate to status and assets with respect to the long-term goal of retirement are shown. The informational items include: a target monthly spending goal, expressed as a dollar amount; a projected monthly spending amount, expressed as a dollar amount and a percentage of the target spending goal; a gap, which represents the difference between the target spending goal and the projected spending amount, expressed in both dollars and percentage; a breakdown of four individual investment accounts, each showing a current value as a dollar amount and an estimated monthly amount that is allocated to the projected monthly spending; and a breakdown of two future income sources, each showing an estimated monthly amount that is allocated to the projected monthly spending.

In an exemplary embodiment, the goal-specific asset allocation module 302 may incorporate several additional features, including any one or more of the following: 1) Plan outputs: Buckets—extend goal-level asset allocation methodology in order to generate asset allocation for goals that leverage the core goal-level funding status calculations; 2) Guidance to optimize plan—i.e., when the funding status of a goal is below 100%, then the goal-specific asset allocation module 302 may generate specific best suggestions customized to client preferences in order to improve outcome, e.g., increase contribution, change retirement location, lower costs, etc.; 3) Tracking progress—ensure understanding as to whether client is on track with goals, and analyze progress attribution, e.g., market fluctuations and/or contribution; 4) Goal discovery/refinements—incorporate additional inputs into the goal-specific asset allocation module 302 based on new data captured as part of goal discovery, education, and refinement experiences; 5) integration with income planning vendor(s); 6) detailed cash flow outputs; and 7) asset allocation glide path.

FIG. 8 is a diagram 800 that illustrates a set of algorithms for determining an optimal asset allocation among asset classes in the context of a long-term financial plan for achieving specific goals in relation to wealth accumulation, according to an exemplary embodiment. As illustrated in the diagram 800, the algorithms may be expressed according to the following formula for weights by target level of probability: 1) Let w be the weight; 2) let x be target probability; 3) let p be percentile of goal cost; 4) let mL be left tail multiple per step; 5) let mR be right tail multiple per step; 6) let sL be the number of probability points per step; and 7) let sR be the dollar amount of probability points per step. Then: 8) IF p>x, THEN w=mL^{∧}((p−x)*100/sL); 9) IF p<x, THEN w=mR^{∧}((−p+x)*100/sR); and 10) IF p=x, THEN w=1. 11) In an exemplary embodiment, mL, mR, sL, sR should each be adjustable by an administrator.

Accordingly, with this technology, an optimized process for adaptively allocating assets and estimating cost objectives in the context of a long-term financial plan for achieving specific goals in relation to wealth accumulation and decumulation is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for adaptively allocating assets in an investment portfolio, the method being implemented by at least one processor, the method comprising:
receiving, by the at least one processor, first information relating to an investment portfolio of an investor;
receiving, by the at least one processor, second information relating to at least one financial goal of the investor;
determining, by the at least one processor based on the second information, a respective estimated cost for achieving each corresponding one of the at least one financial goal;
determining, by the at least one processor based on the first information and the second information, a current status and at least one proposed adjustment that relate to achieving the at least one financial goal; and
outputting, by the at least one processor, third information that relates to each determined estimated cost, the determined current status, and the determined at least one proposed adjustment.

2. The method of claim 1, wherein the first information includes an identification of each of a plurality of financial assets included in the investment portfolio and a value of each identified financial asset.

3. The method of claim 2, wherein the first information further includes a projection relating to future income that is expected to be received within a predetermined time frame.

4. The method of claim 1, wherein the at least one financial goal includes at least one from among a retirement goal, a health care goal, a goal that relates to funding for a college education, a goal that relates to purchasing real estate, a goal that relates to purchasing a tangible object, a goal that relates to an inheritance to be bequeathed to at least one heir, a goal that relates to a charitable contribution, and a goal that relates to current liquidity.

5. The method of claim 4, wherein the second information includes an identification of each respective one of the at least one financial goal, a corresponding estimated probability of achieving each identified financial goal, and a rank-ordered listing that indicates a relative importance of each identified financial goal.

6. The method of claim 1, wherein the at least one proposed adjustment includes a proposed adjustment to an asset allocation among a plurality of asset classes.

7. The method of claim 1, wherein the determining of the respective estimated cost for achieving each corresponding one of the at least one financial goal comprises applying a first algorithm with respect to the first information and the second information and using a plurality of simulations to generate a range of outcomes of the respective estimated cost as an output of the first algorithm.

8. The method of claim 1, further comprising displaying, via a graphical user interface (GUI), at least a portion of the third information.

9. The method of claim 8, wherein the GUI includes at least one from among a first clickable link that facilitates access to explanatory information that relates to the displayed portion of the third information and a second clickable link that facilitates a user selection of a risk level that is associated with the displayed portion of the third information.

10. A computing apparatus for adaptively allocating assets in an investment portfolio, the computing apparatus comprising:
a processor;
a memory;
a display; and
a communication interface coupled to each of the processor, the memory, and the display,
wherein the processor is configured to:
receive, via the communication interface, first information relating to an investment portfolio of an investor;
receive, via the communication interface, second information relating to at least one financial goal of the investor;
determine, based on the second information, a respective estimated cost for achieving each corresponding one of the at least one financial goal;
determine, based on the first information and the second information, a current status and at least one proposed adjustment that relate to achieving the at least one financial goal; and
output third information that relates to each determined estimated cost, the determined current status, and the determined at least one proposed adjustment.

11. The computing apparatus of claim 10, wherein the first information includes an identification of each of a plurality of financial assets included in the investment portfolio and a value of each identified financial asset.

12. The computing apparatus of claim 11, wherein the first information further includes a projection relating to future income that is expected to be received within a predetermined time frame.

13. The computing apparatus of claim 10, wherein the at least one financial goal includes at least one from among a retirement goal, a health care goal, a goal that relates to funding for a college education, a goal that relates to purchasing real estate, a goal that relates to purchasing a tangible object, a goal that relates to an inheritance to be bequeathed to at least one heir, a goal that relates to a charitable contribution, and a goal that relates to current liquidity.

14. The computing apparatus of claim 13, wherein the second information includes an identification of each respective one of the at least one financial goal, a corresponding estimated probability of achieving each identified financial goal, and a rank-ordered listing that indicates a relative importance of each identified financial goal.

15. The computing apparatus of claim 10, wherein the at least one proposed adjustment includes a proposed adjustment to an asset allocation among a plurality of asset classes.

16. The computing apparatus of claim 10, wherein the processor is further configured to determine the respective estimated cost for achieving each corresponding one of the at least one financial goal by applying a first algorithm with respect to the first information and the second information and by using a plurality of simulations to generate a range of outcomes of the respective estimated cost as an output of the first algorithm.

17. The computing apparatus of claim 10, wherein the processor is further configured to cause the display to display, via a graphical user interface (GUI), at least a portion of the third information.

18. The computing apparatus of claim 17, wherein the GUI includes at least one from among a first clickable link that facilitates access to explanatory information that relates to the displayed portion of the third information and a second clickable link that facilitates a user selection of a risk level that is associated with the displayed portion of the third information.

19. A non-transitory computer readable storage medium storing instructions for adaptively allocating assets in an investment portfolio, the storage medium comprising executable code which, when executed by a processor, causes the processor to:
receive first information relating to an investment portfolio of an investor;
receive second information relating to at least one financial goal of the investor;
determine, based on the second information, a respective estimated cost for achieving each corresponding one of the at least one financial goal;
determine, based on the first information and the second information, a current status and at least one proposed adjustment that relate to achieving the at least one financial goal; and
output third information that relates to each determined estimated cost, the determined current status, and the determined at least one proposed adjustment.

20. The storage medium of claim 19, wherein the first information includes an identification of each of a plurality of financial assets included in the investment portfolio and a value of each identified financial asset.
